(19) United States
(12) Patent Application Publication
(10) Pub. No.: US 2006/0159263 A1
(43) Pub. Date: Jul. 20, 2006

(54) Scrambled state display method of broadcasting signal

(75) Inventors: Sang Hoon Cha, Seoul (KR); Sung Deuk Cho, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/333,246

(22) Filed: Jan. 18, 2006

(30) Foreign Application Priority Data
Jan. 19, 2005 (KR) 4877 / 2005

(51) Int. Cl. H04K 1/06; H04N 7/167; H04K 1/04

(52) U.S. Cl. 380/210; 380/37

(57) ABSTRACT

A scrambled state display method of a broadcasting signal is disclosed whereby discrimination is made as to whether cable TV broadcasting signal is a scrambled A/V stream and it is displayed on a screen. If a channel switchover command is inputted, a tuner is made to tune to a broadcasting signal of a relevant channel, and header information is extracted from a transport packet stream of the tuned channel of the tuner. The broadcasting signal is discriminated as to whether it is a scrambled signal by a value of a transport scrambling control in the head information, and if it is discriminated that the broadcasting signal is a scrambled signal, it is displayed by an OSD signal, enabling a viewer to check.

This application claims the benefit of the Korean Application No. 10-2005-0004877 filed on Jan. 19, 2005, which is hereby incorporated by reference.

### BACKGROUND OF THE INVENTION

1. Field of the Invention

The present invention relates to a scrambled state display method of a broadcasting signal whereby a scrambled signal is informed to a user if an Audio/Video (A/V) stream of a broadcasting signal received by a broadcasting signal receiver is the scramble signal.

2. Description of the Related Art

Presently, broadcasting signal receivers such as television receivers and set-top boxes receive and process broadcasting signals transmitted via terrestrial wave, satellites and cables for users to view.

For a particular channel in some of the broadcasting signals received by the broadcasting receivers, an A/V stream is scrambled for Pay Per View (PPV) Programs by broadcasting stations and provided to a user.

In order to normally view the scrambled A/V stream, a descrambling card capable of restoring the scrambled A/V stream to a descrambled state should be provided. A broadcasting receiver not equipped with a descrambling apparatus cannot normally decode a scrambled A/V stream of a predetermined channel so that a user cannot view the scrambled A/V stream.

In such a case, it is necessary to inform a user of a state that an A/V stream of a broadcasting signal received by the broadcasting receiver has been scrambled and cannot be normally viewed.

However, the broadcasting receiver not equipped with a descrambling apparatus processes a screen with a blacked picture or displays a message of NO SIGNAL on the blacked screen in order to conceal a display of NOISE ONLY on the screen if the scrambled channel of A/V stream is selected.

As a result, views cannot discriminate whether a cable broadcasting signal of a relevant channel cannot be viewed due to the scrambled A/V stream, and are confused, misunderstanding that the cable broadcasting signal is not available.

### SUMMARY OF THE INVENTION

It is an object of the present invention to provide a scrambled state display method of a broadcasting signal whereby a scrambled signal is informed to a user if an Audio/Video (A/V) stream of a broadcasting signal received by a broadcasting signal receiver is the scramble signal.

In the scrambled state display method of a broadcasting signal according to the present invention, a transport packet stream broadcast by a broadcasting station in a predetermined channel is tuned by a tuner and received, and discrimination is made as to whether an A/V stream in the received transport packet stream is scrambled by a transport scrambling control contained in a header.

If the A/V stream is scrambled, discrimination is made as to whether a descrambling apparatus is mounted, and if the descrambling apparatus is not disposed, a TV screen is displayed that the A/V stream is scrambled, so that a user is informed that a broadcasting signal of a current channel cannot be normally viewed.

The scrambled state is displayed by an OSD (On Screen Display) signal while the TV screen is blackened.

According to the object of the present invention, the scrambled state display method of a broadcasting signal comprises: discriminating whether an A/V stream of transport packet stream received by a tuner is scrambled; a decoder/controller informing a user that the A/V stream is scrambled if the A/V stream is scrambled as a result of the discrimination.

The scrambling discrimination of the A/V stream is performed in an initial stage of switchover of a receiving channel of the tuner.

The scrambling discrimination of the A/V stream is performed in an initial stage of operation after a power of a broadcasting signal receiver is turned on.

The scrambling discrimination of the A/V stream is performed by a transport scrambling control contained in a header of a transport packet stream.

The step of informing that the A/V stream is scrambled comprises displaying on a screen of a TV by an OSD (On Screen Display) signal. The step of informing that the A/V stream is scrambled comprises blackening a screen of a TV.

The step of informing that the A/V stream is scrambled comprises: discriminating whether a descrambling apparatus is mounted; displaying that the A/V stream is scrambled if the descrambling apparatus is not mounted; displaying on a screen of a TV by an OSD (On Screen Display) signal; and blackening a screen of a TV.

If the descrambling apparatus is mounted, the scrambled A/V stream is descrambled and decoded for a user to view the screen.

The step of informing that the A/V stream is scrambled is performed if it is discriminated that the A/V stream is scrambled more than a pre-set frequency.

If it is discriminated that the A/V stream is not scrambled, the A/V stream is decoded by a decoder/controller for a user to view the screen.

### BRIEF DESCRIPTION OF THE DRAWINGS

FIG. 1 is a diagram explaining a structure of transport packet stream of a broadcasting signal.

FIG. 2 is a block diagram illustrating a structure of a broadcasting receiver according to the present invention.

FIG. 3 is a signal flowchart explaining a display method according to the present invention.

### DETAILED DESCRIPTION OF THE INVENTION

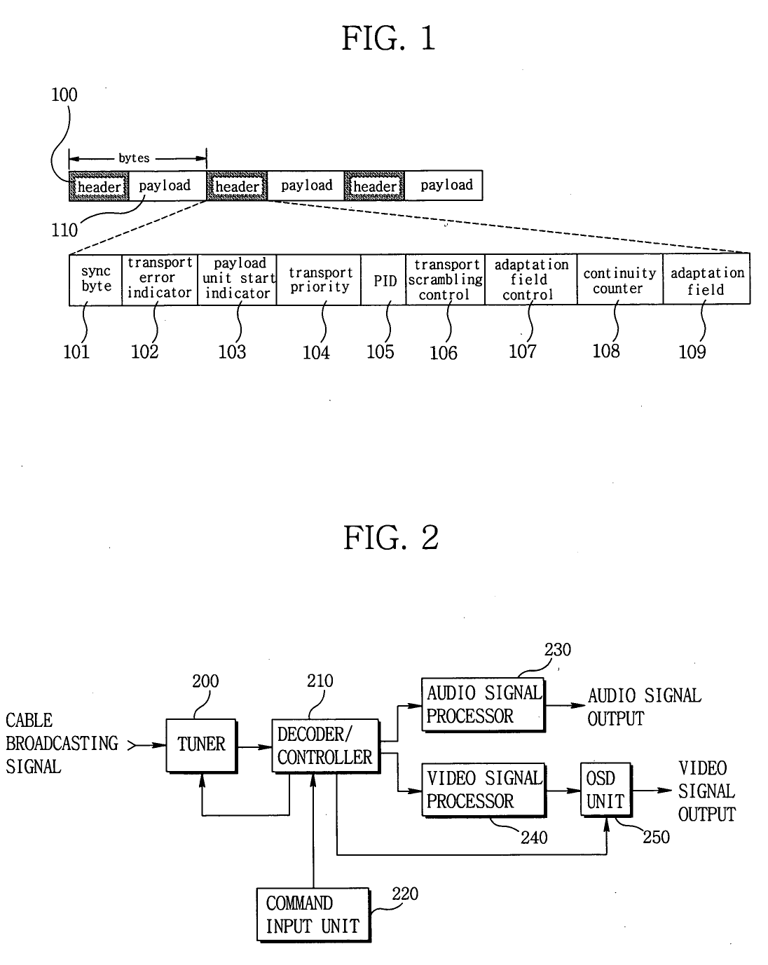

FIG. 1 is a diagram explaining a structure of transport packet stream of a broadcasting signal via terrestrial wave, satellites or cables. As shown in FIG. 1, the transport packet stream is alternatively and continuously broadcast by a header 100 and a payload 110 in 188 bytes.

The header 100 includes a synchronous byte 101, a transport error indicator 102, a payload unit start indicator 103, a transport priority 104, a packet identification (PID) 105, a transport scrambling control 106, an adaptation field control 107, a continuity counter 108 and an adaptation field 109.

The synchronous byte 101 is a start code informing that the head 100 has started, and has a value of, for example, ‘0100 0111’. The transport error indicator 102 consists of 1 bit informing whether an error has occurred to a transport signal. The payload unit start indicator 103 is a 1-bit signal informing a start position of a payload 110. The transport priority 104 is a 1-bit signal informing a priority of transport packet stream. The PID 105 is comprised of 13 bits informing whether information transported to a payload region is an audio signal or a video signal. The transport scrambling control 106 is a 2-bit signal informing whether a transporting AV stream has been scrambled. The adaptation field control 107 is a 2-bit signal informing whether the header 100 has been expanded. The continuity counter 108 is a 4-bit signal informing a counter value of same PID. The adaptation field 109 is an expanded signal and is included when it is informed that the header 100 has been expanded by the adaptation field control 107, and is not included when it is not informed that the header 100 has been expanded by the adaptation field control 107.

In the header 100 of transport packet stream thus constructed, whether an A/V stream to be transported by being inserted into a payload 110 region has been scrambled can be discriminated by the transport scrambling control 106 comprised of 2 bits. In other words, if the 2-bit transport scrambling control 106 is ‘0’, it means that the A/V stream has not been scrambled, and in this case, a broadcasting receiver can normally decode the A/V stream for viewing. However, if the 2-bit transport scrambling control 106 is not ‘0’, it means that the A/V stream has been scrambled.

The scrambled A/V stream should be descrambled by a descrambling apparatus for a broadcasting receiver to normally decode and view a TV screen, and if there is no descrambling apparatus, the broadcasting receiver cannot normally decode the A/V stream for viewing.

FIG. 2 is a block diagram illustrating a structure of a broadcasting receiver according to the present invention, where reference numeral 200 denotes a tuner. The tuner 200 receives a broadcasting signal of a predetermined channel out of broadcasting signals transmitted via terrestrial wave, satellites or cables, and extracts a transport packet stream out of the received broadcasting signals.

Reference numeral 210 denotes a decoder/controller. The decoder/controller 210 serves to decode the transport packet stream extracted by the tuner 200 to separate the A/V stream, and separates an audio signal and a video signal out of the separated A/V stream. The decoder/controller 210 controls an operation of a broadcasting receiver in response to an operation command and also controls in such a manner that the tuner 200 can receive a broadcasting signal of a predetermined channel. Further more, the decoder/controller 210 discriminates whether the A/V stream has been scrambled by the transport scrambling control 106 contained in the header 100 of the transport packet stream, and if scrambled, controls in such a manner that the scrambled A/V stream is displayed on a screen.

Reference numeral 220 denotes a command input unit. The command input unit 220 creates a switchover command of a broadcasting signal in response to manipulation of a user, and outputs the created switchover command to the decoder/controller 210.

Reference numeral 230 is an audio signal processor. The audio signal processor 230 processes an audio signal separated by the decoder/controller 210. Reference numeral 240 denotes a video signal processor. The video signal processor 240 processes a video signal separated by the decoder/controller 210.

Reference numeral 250 denotes an OSD (On Screen Display) unit. The OSD unit 250 generates an OSD signal informing of a scrambling signal in response to control of the decoder/controller 210, and synthesizes the generated OSD signal with the video signal processed by the video signal processor 240.

The broadcasting receiver thus constructed is operated in such a manner that a user instructs receipt of a predetermined channel via the command input unit 220. The decoder/controller 210 then controls the tuner 200 in response to the received command of the predetermined channel to tune a broadcasting signal of a relevant channel out of the broadcasting signals.

The tuner 200 tunes a broadcasting signal of a predetermined channel according to control of the decoder/controller 210, and extracts a transport packet stream from the tuned broadcasting signal and inputs it to the decoder/controller 210.

The decoder/controller 210 decodes the transport packet stream inputted from the tuner 200 and extracts the header 100. Furthermore, the decoder/controller 210 discriminates whether the A/V stream has been scrambled from the extracted header 100 by way of value of the transport scrambling control 106.

As a result of the discrimination, if a value of the transport scrambling control 106 is ‘0’ and it is informed that the A/V stream has not been scrambled, the decoder/controller 210 normally decodes the A/V stream to separate the audio signal from the video signal. The separated audio signal is processed and outputted by the audio signal processor 130, and the video signal is processed by the video signal processor 240 and outputted via the OSD unit 250 to allow viewing of the A/V signal of a relevant channel by a user.

Furthermore, if it is informed that the A/V stream has been scrambled by other value than ‘0’ of the transport scrambling control 106 as a result of the discrimination, the decoder/controller 210 discriminates whether a descrambling apparatus (not shown) is mounted. If the descrambling apparatus is disposed, the decoder/controller 210 descrambles the A/V stream by way of the descrambling apparatus, and decodes and separates the A/V signal. The separated A/V signal is processed and outputted by the audio signal processor 130 and the video signal processor 240 to allow viewing of the A/V signal of a relevant channel by a user.

If the descrambling apparatus is not equipped, the decoder/controller 210 discriminates that the A/V stream cannot be descrambled to control the OSD unit 250 according to the present invention, and for example, blackens a screen, and displays an OSD signal of guidance message on the screen saying that “DESRAMBLER IS NEEDED”.

Then, the user can check the guidance message of the OSD signal displayed on the screen, contacts a relevant broadcasting station to purchase and view with the installment of a descrambling apparatus if he or she desires to view the relevant channel of the broadcasting station.

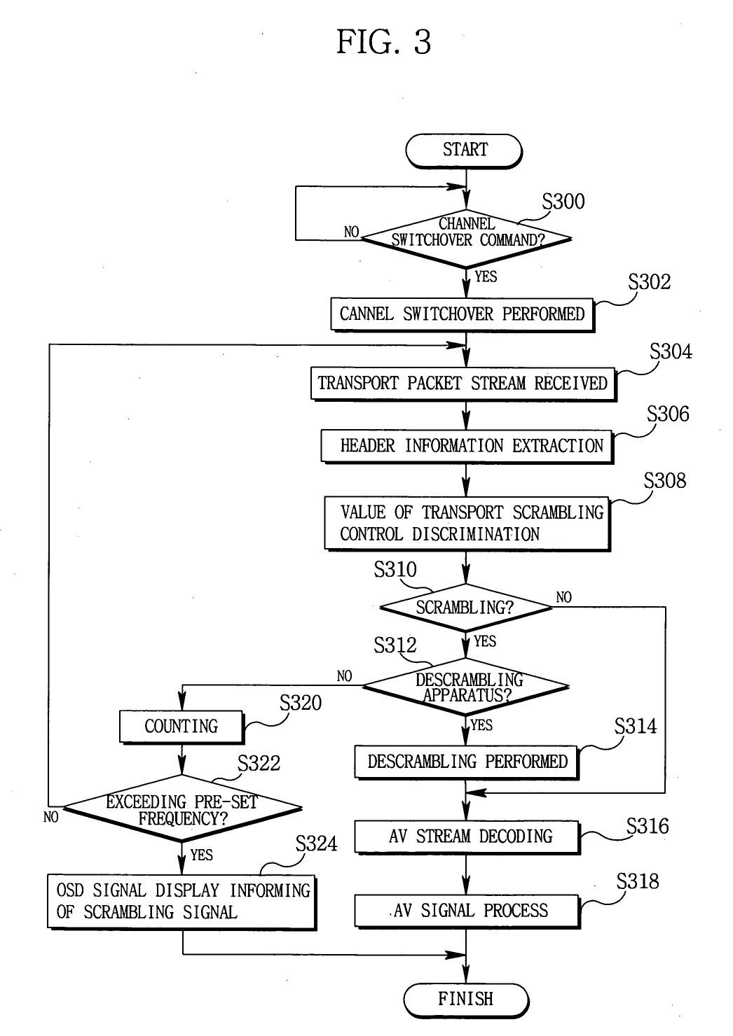

Meanwhile, FIG. 3 is a signal flowchart explaining a display method according to the present invention.

Referring to FIG. 3, the decoder/controller 210 discriminates whether a channel switchover command has been inputted from a command input unit 220, instructing that a channel of currently-tuned broadcasting signal be switched to other channel (S300).

If channel switchover command is inputted, the decoder/controller 210 controls the tuner 200 to allow tuning to a predetermined broadcasting signal in response to the channel switchover command (S302).

The tuner 200 then tunes to the broadcasting signal of a relevant channel in response to the channel switchover command to receive a transport packet stream (S304).

Under this circumstance, at the start of switching on the broadcasting receiver, the tuner 200 may also tune to a broadcasting signal of a predetermined channel to receive a transport packet stream.

If the tuner 200 receives the transport packet stream, the decoder/controller 210 extracts information of the header 100 from the received transport packet stream (S306).

The decoder/controller 210 determines a value of the transport scrambling control 106 from the extracted information of the header 100 (S308) to discriminate whether the A/V stream of the payload 110 has been scrambled (S310).

As a result of the discrimination, if it is discriminated that value of the transport scrambling control is ‘0’ and the A/V stream has not been scrambled, the decoder/controller 210 decodes the A/V stream of the payload 110 to separate the A/V signal (S316), and processes the separated A/V signal to allow viewing of a relevant channel of broadcasting signal by a user (S318).

Furthermore, as a result of the discrimination, if it is determined that the value of the transport scrambling control has other value than ‘0’ and the A/V stream has been scrambled, the decoder/controller 210 discriminates whether a descrambling apparatus is disposed for descrambling the A/V stream of the payload 110 (S312).

If it is discriminated that a descrambling apparatus is mounted, the decoder/controller 210 performs the descrambling of the A/V stream of the payload 110 by way of the descrambling apparatus. The descrambled A/V stream is decoded and the A/V signal is separated (S316), and the separated A/V signal is processed to allow viewing of a relevant channel of broadcasting signal by a user (S318).

As a result of discrimination, if it is discriminated that the A/V stream has been scrambled by a value other than ‘0’, and a descrambling apparatus is not disposed, the decoder/controller 210 counts a discriminating frequency of not being able to perform the descrambling of the A/V stream (S320), and determines whether a counted value exceeds a pre-set frequency of, for example, 3 (S322).

Under this circumstance, the reason of determining whether descrambling cannot be performed over the pre-set frequency is to prevent an occurrence of error in advance if the received transport packet stream is incorrectly inputted.

If it is determined that the counted value has not exceeded the pre-set frequency, the decoder/controller 210 re-receives the transport packet stream (S304), and repeats an operation (S322) of discriminating whether the counted value of having determined that the A/V stream cannot be descrambled exceeds the pre-set frequency.

If it is discriminated that the counted value of having determined that the A/V stream cannot be descrambled exceeds the pre-set frequency, the decoder/controller 210 controls the OSD unit 250 to blacken the screen, and creates an OSD signal of guidance message saying that “DESCRAMBLER IS NEEDED” for display on the screen.

As described above, the present invention is operated in such a manner that discrimination is made as to whether an A/V stream has been scrambled by a value of transport scrambling control contained in a header in a transport packet stream received by a switched-over channel if a channel of a broadcasting receiver is to be switched over, and discrimination is made as to whether a descrambling apparatus is disposed if the A/V stream has been scrambled.

A screen is blackened or an OSD signal is displayed on the screen, saying that a broadcasting signal is a scrambled signal instead of displaying “NO SIGNAL”, if the A/V stream has been scrambled, and a descrambling apparatus is not equipped disabling to normally view the broadcasting signal.

Consequently, a user can surely understand that a current broadcasting signal of a channel has been scrambled, and be invited to contact a relevant broadcasting station to pay the view by installing a descrambling apparatus if he or she desires to view a broadcasting signal of relevant channel.

Although the embodiment of the present invention has been shown and described, the present invention is not limited to the described embodiment. Instead, it would be appreciated by those skilled in the art that various changes may be made to the embodiment without departing from the principles and spirit of the invention, the scope of which is defined by the claims and their equivalents.

What is claimed is:

1. A scrambled state display method of a broadcasting signal comprising: discriminating whether an A/V stream of transport packet stream received by a tuner is scrambled; a decoder/controller informing a user that the A/V stream is scrambled if the A/V stream is scrambled as a result of the discrimination.

2. The method as defined in claim 1, wherein the scrambling discrimination of the A/V stream is performed in an initial stage of switchover of a receiving channel of the tuner.

3. The method as defined in claim 1, wherein the scrambling discrimination of the A/V stream is performed in an initial stage of operation after a power of a broadcasting signal receiver is turned on.

4. The method as defined in claim 1, wherein the scrambling discrimination of the A/V stream is performed by a transport scrambling control contained in a header of a transport packet stream.

5. The method as defined in claim 1, wherein the step of informing that the A/V stream is scrambled comprises displaying on a screen of a TV by an OSD (On Screen Display) signal.

6. The method as defined in claim 5, wherein the step of informing that the A/V stream is scrambled comprises blackening a screen of a TV.

7. The method as defined in claim 1, wherein the step of informing that the A/V stream is scrambled comprises: discriminating whether a descrambling apparatus is mounted; displaying that the A/V stream is scrambled if the descrambling apparatus is not mounted; displaying on a screen of a TV by an OSD (On Screen Display) signal; and blackening a screen of a TV.

8. The method as defined in claim 7, wherein the step of informing that the A/V stream is scrambled comprises displaying on a screen of a TV by an OSD (On Screen Display) signal.

9. The method as defined in claim 8, wherein the step of informing that the A/V stream is scrambled comprises blackening a screen of a TV and displaying in OSD signal.

10. The method as defined in claim 7, wherein if the descrambling apparatus is mounted, the scrambled A/V stream is descrambled and decoded for a user to view the screen.

11. The method as defined in claim 1, wherein the step of informing that the A/V stream is scrambled is performed if it is discriminated that the A/V stream is scrambled more than a pre-set frequency.

12. The method as defined in claim 1, wherein if it is discriminated that the A/V stream is not scrambled, the A/V stream is decoded by a decoder/controller for a user to view the screen.
